(19) United States
(12) Patent Application Publication
(10) Pub. No.: US 2025/0319824 A1
(43) Pub. Date: Oct. 16, 2025

(54) WHEEL DOLLY STORAGE FOR A PICKUP TRUCK BED

(71) Applicant: Michael Farrell, Detroit, MI (US)

(72) Inventor: Michael Farrell, Detroit, MI (US)

(21) Appl. No.: 19/175,826

(22) Filed: Apr. 10, 2025

Related U.S. Application Data
(60) Provisional application No. 63/632,396, filed on Apr. 10, 2024.

(51) Int. Cl. B60R 9/06

(52) U.S. Cl. CPC B60R 9/06

(57) ABSTRACT

A dolly storage system for storing a dolly in a bed of a pickup truck including one or more slidable tubes positioned within an interior of a truck bed; a dolly; a mounting system connected to the one or more slidable tubes, the mounting system configured to connect to the dolly; and an articulating arm coupling the mounting system to the dolly, wherein the one or more slidable tubes and the articulating arm are configured to enable movement of the dolly between a stowed configuration within the interior of the truck bed and an extended configuration outside of the truck bed.

### CROSS-REFERENCE TO RELATED APPLICATIONS

The present application claims priority to U.S. Provisional Application No. 63/632,396 filed Apr. 10, 2024, titled “WHEEL DOLLY STORAGE FOR A PICKUP TRUCK BED,” which is hereby incorporated by reference in its entirety.

### TECHNICAL FIELD

The embodiments generally relate to the technical field of vehicle storage and transportation accessories, and more particularly to a dolly storage system for pickup truck beds.

### BACKGROUND

Conventional tow dollies typically connect to a towing vehicle by a hitch or coupling system and rely on the towing vehicle for mobility and braking. Tow dollies allow operators to move disabled or unpowered vehicles with minimal setup and without the need for full flatbed trailers.

When not in use, tow dollies often require storage in or on the towing vehicle, such as within the bed of a pickup truck. In many cases, operators manually place the dolly in the truck bed, where it may remain loose or minimally secured. Some truck beds include anchoring hooks or tie-down points to assist with temporary restraint. However, these measures often require manual effort to secure and remove the dolly and do not provide a dedicated storage mechanism.

Conventional storage solutions for tow dollies may involve additional accessories or retrofitted components, such as ramps or brackets, but these systems frequently lack integration with the vehicle structure or require disassembly for access. In some cases, users rely on makeshift arrangements to transport the dolly, which can result in shifting during transport, difficult retrieval, or time-consuming setup. Storage and handling challenges are particularly notable when the dolly is heavy or when the operator must maneuver it within the confined space of a truck bed.

### SUMMARY

This summary is provided to introduce a variety of concepts in a simplified form that is further disclosed in the detailed description of the embodiments. This summary is not intended to identify key or essential inventive concepts of the claimed subject matter, nor is it intended to determine the scope of the claimed subject matter.

A dolly storage system for a pickup truck enables efficient, secure, and convenient transport and deployment of a tow dolly within the bed of the truck. The system includes one or more slidable tubes positioned within the interior of the truck bed and configured to extend and retract along a longitudinal axis. A mounting system connects to the slidable tubes and is configured to secure a dolly. An articulating arm couples the mounting system to the dolly, enabling movement between a stowed configuration within the bed and an extended configuration for deployment.

The integration of telescoping tubes and an articulating arm allows operators to store and deploy the dolly without manual lifting or reliance on separate ramps or restraints. In some embodiments, the telescoping tubes lock into multiple positions to support a range of truck bed lengths or deployment angles. The articulating arm may include pivoting or folding mechanisms to reduce the spatial footprint of the system when not in use.

The mounting system may include adjustable brackets or fasteners to accommodate dollies of various sizes and to maintain secure positioning during vehicle transport. In certain configurations, the dolly is removably attached to the articulating arm, allowing the user to detach and reposition the dolly as needed without modifying the storage system itself.

The dolly storage system addresses common challenges associated with conventional storage approaches, such as unsecured dolly movement, complex retrieval, and risk of injury during manual lifting. By integrating the storage, securing, and deployment features into a single system within the truck bed, the disclosed configurations reduce operator effort and improve transport safety.

Additional embodiments may include powered actuators for extending the slidable tubes or gas-assist struts for the articulating arm. These enhancements further improve usability, especially in professional or commercial applications where frequent dolly deployment is required.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a top plan view of the truck bed and dolly storage system, wherein the dolly storage system is in a stowed configuration, according to some embodiments;

FIG. 2 illustrates a perspective view of the truck bed and dolly storage system, wherein the dolly storage system is in a stowed configuration, according to some embodiments;

FIG. 3 illustrates a top plan view of the truck bed and dolly storage system, wherein the dolly storage system is in an extended configuration, according to some embodiments;

FIG. 4 illustrates a perspective view of the truck bed and dolly storage system, wherein the dolly storage system is in an extended configuration, according to some embodiments;

FIG. 5 illustrates a top plan view of the truck bed and dolly storage system, wherein the dolly storage system is in an extended configuration having the arm folded down, according to some embodiments; and

FIG. 6 illustrates a perspective view of the truck bed and dolly storage system, wherein the dolly storage system is in an extended configuration having the arm folded down, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing exemplary embodiments in detail, it is noted that the embodiments reside primarily in combinations of components related to devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

A dolly storage system may be implemented in the bed of a pickup truck to store and deploy a dolly for use in towing a vehicle. The system may include one or more slidable tubes positioned within the interior of the truck bed. These slidable tubes may be configured to extend and retract along the longitudinal axis of the truck bed and may be secured to the truck bed using brackets, fasteners, or weldments. The slidable tubes may operate as linear guides for supporting other components of the storage system and may include bearings or bushings to reduce friction during movement.

The slidable tubes may be formed as telescoping members, such as concentric square or circular metal tubes that collapse into one another when retracted. In some embodiments, the telescoping tubes may include integrated locking mechanisms that allow them to lock at one or more fixed extension lengths. Such locking mechanisms may include spring-loaded pins, detent buttons, or rotating collars that engage corresponding holes or grooves along the length of the tubes.

Mounted to the slidable tubes may be a mounting system, which may serve as an intermediate structural component between the tubes and the dolly. The mounting system may be composed of a rigid platform, bracket assembly, or sliding carriage. In some embodiments, the mounting system may include fasteners, clamps, or retaining pins that connect to the dolly's chassis or axle support structure. The mounting system may be configured to accommodate various dolly sizes, and in some cases, may include slotted or adjustable mounting points to allow repositioning for width or length variations.

An articulating arm may be coupled between the mounting system and the dolly. The articulating arm may be formed of one or more rigid members connected by a hinge or pivot joint. This arm may allow the dolly to swing or rotate out from the truck bed as the slidable tubes extend, transitioning the dolly from a stowed configuration within the interior of the truck bed to an extended configuration outside the truck bed. In some implementations, the articulating arm may be foldable to reduce its profile in the stowed configuration. The folding function may be achieved by a hinge mechanism that allows the arm to rotate about a horizontal or vertical axis.

To support the articulating motion, the system may include a hinge or pivot assembly between the mounting system and the articulating arm. This assembly may allow for rotational movement along one or more axes. A pin joint, ball joint, or clevis assembly may provide the required degrees of freedom for deployment. The hinge may be manually operated or assisted by spring-loaded mechanisms or gas struts to reduce user effort during extension or retraction. In some configurations, the articulating arm may include detents or locking positions to hold the dolly at specific deployment angles.

A locking mechanism may be used to retain the articulating arm in either the stowed or extended configuration. This mechanism may consist of a latch, over-center lock, cam lock, or pin-and-hole system. The locking system may be engaged manually or may include automatic engagement features triggered by the arm reaching a defined angle or position.

The dolly may be any type of unpowered, wheeled transport frame configured to engage a vehicle's wheels during towing. The dolly may include an axle, wheel assemblies, a coupling interface, and one or more loading ramps. In some implementations, the dolly may include a wheel-locking mechanism to prevent movement while stored. This may be achieved with integrated brakes, wheel chocks, or tie-down points that secure the dolly to the mounting system during transport.

In some configurations, the mounting system may allow for quick-release or removable attachment of the dolly. This may include the use of latch pins, toggle clamps, or quick-connect hardware to facilitate tool-less removal of the dolly when needed. The mounting system may also support additional tie-downs, straps, or brackets to secure the dolly during motion of the towing vehicle.

In other implementations, the dolly storage system may include a base carriage fixed to the telescoping tubes. The base carriage may ride along the length of the tubes and may serve as the structural interface for the articulating linkage arm. The carriage may include bushings, rails, or rollers to guide its motion. The carriage may be removably mounted using a locking pin or screw-based assembly to allow detachment for maintenance or reconfiguration.

The articulating linkage arm may extend upward or laterally from the base carriage and may be formed of tubular or plate material. In some embodiments, the linkage arm may include a gas strut, spring, or torsion-assist mechanism to aid in its rotation. These assistive elements may reduce the manual force required by the operator and may prevent abrupt movement. The arm may be designed to pivot about a horizontal axis such that the dolly can be gently lowered or raised during deployment.

A manual or powered actuator may be coupled to the telescoping tubes to control their extension. The actuator may be a linear screw, hydraulic cylinder, pneumatic piston, or electric motor assembly. Control of the actuator may be performed via a remote switch, handle, or integrated button mounted within the truck bed. In powered systems, the actuator may draw power from the vehicle battery or a separate rechargeable power source.

In an alternate configuration, the system may be implemented as a vehicle-mounted dolly deployment system comprising a track system disposed longitudinally in the truck bed. The track system may include one or more telescoping rails, similar in function to drawer slides or cargo rollers, and may support a cradle platform. The cradle platform may be configured to carry the dolly and may be contoured to match the shape of the dolly's frame or base. The cradle may include mounting brackets, rubberized pads, or anti-slip surfaces to stabilize the dolly.

Affixed to the cradle platform may be a swingable arm member. This member may rotate laterally from a stowed position aligned with the truck bed to an extended position adjacent the vehicle. The swingable arm member may include rotational stops, detents, or locking positions to prevent overextension. The dolly may be mounted to the swingable arm via a removable latch mechanism, which may include a hook-and-loop interface, bolt-on plate, or cam lock to retain the dolly during movement.

The track system may include one or more guide rails and a rolling platform or shuttle, which may translate forward and backward within the bed. Bearings, casters, or linear slides may reduce resistance during movement. The cradle platform may be rigidly or flexibly coupled to the rolling platform depending on desired functionality. In some embodiments, a lift-assist spring or ramp assembly may assist in the final positioning of the dolly.

The system may be adapted to fit various truck bed lengths and widths and may be manufactured using steel, aluminum, or composite materials to reduce weight while maintaining strength. Modular components may allow the system to be retrofitted onto existing truck beds without welding or drilling. Mounting hardware may include U-bolts, clamps, or adhesive pads depending on the installation scenario.

Users may operate the system by opening the truck bed tailgate, releasing any securing locks, and extending the slidable tubes or track assembly. The articulating arm or swingable member may then be rotated outward, placing the dolly in a position suitable for use. After deployment, the dolly may be removed or secured to a vehicle for towing. When storage is desired, the user may reverse the steps, folding and retracting components until the dolly is secured within the truck bed.

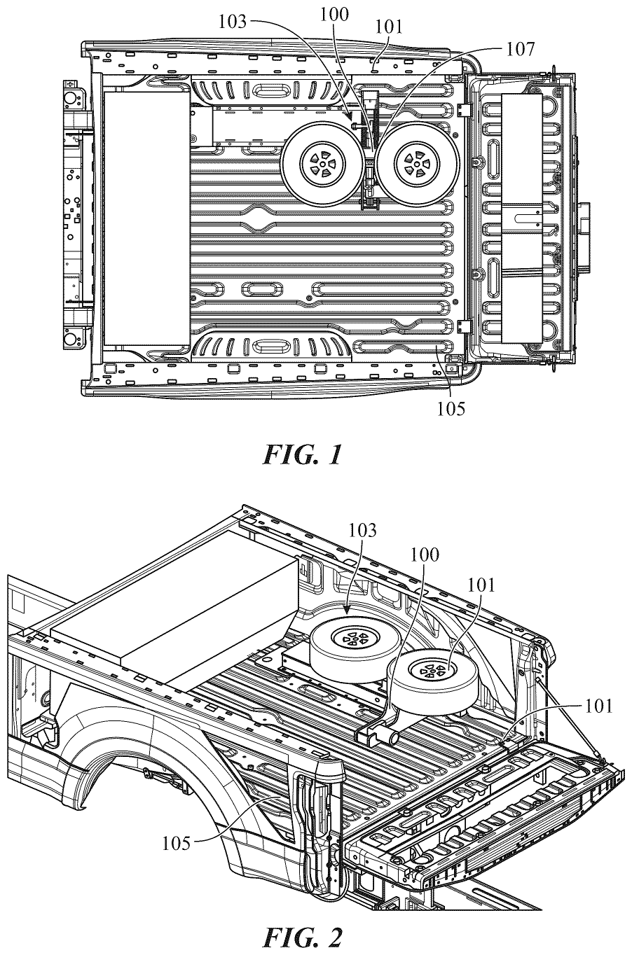

FIG. 1 and FIG. 2 illustrate the dolly storage system 100 within a truck bed 101, wherein the dolly storage system 100 is in a stowed configuration 103 within the interior 105 of the truck bed 101. The interior 105 of the truck bed 101 may be defined as the space between the walls and tailgate of the truck bed 101. The dolly storage system 100 allows for the dolly 107 to be contained within the truck bed 101 while the operator can easily remove the dolly 107 via slidable tubes and an articulating arm.

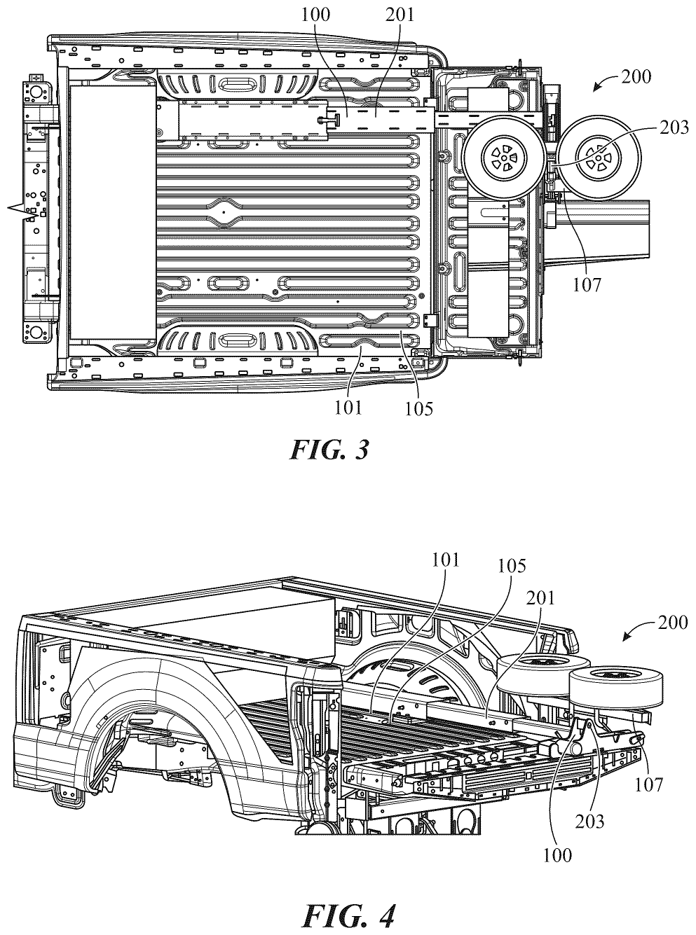

FIG. 3 and FIG. 4 illustrate truck bed 101 and dolly storage system 100, wherein the dolly storage system 100 is in an extended configuration 200. The extended configuration 200 is defined as the dolly 107 being extended from the interior 105 of the truck bed 101 to allow an operator to access the dolly 107 prior and during use, as well as during the process of storing the dolly 107. The dolly storage system includes one or more slidable tubes 201 which are mounted or otherwise positioned within the interior 105 of the truck bed 101. A mounting system 203 connects the dolly 107 to the slidable tubes 201 to retain the dolly 107 on the dolly storage system during transport to prevent the dolly 107 from rolling or otherwise moving within the truck bed 101.

The slidable tubes 201 include telescoping members which extend and retract between the stowed configuration 103 and the extended configuration 200. In such, the user can easily extend or retract the slidable tubes 201 to move the dolly storage system 100 between the stowed and extended configurations.

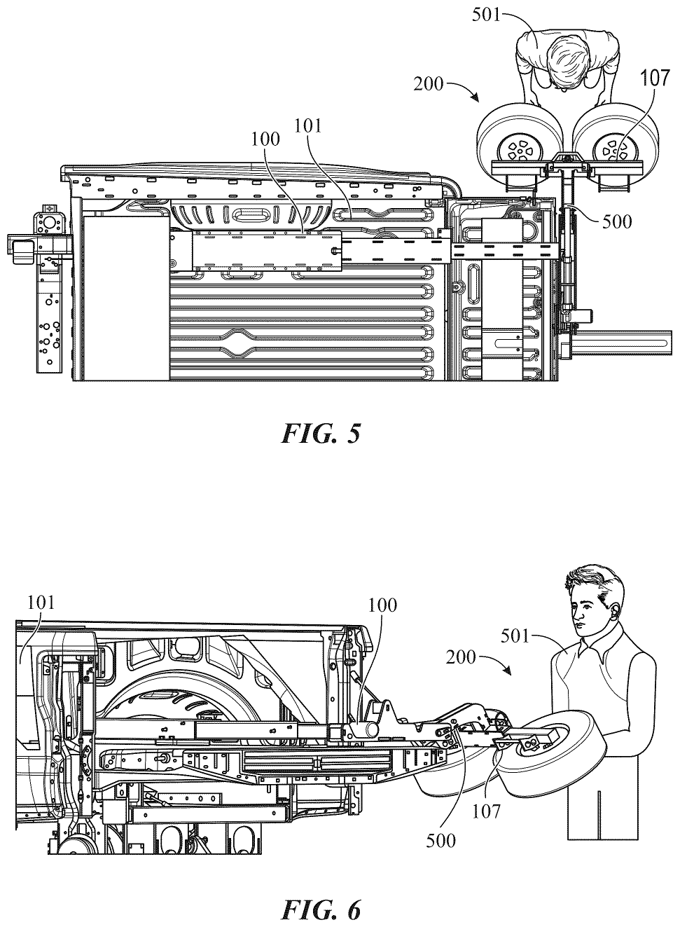

FIG. 5 and FIG. 6 illustrate the truck bed 101 and dolly storage system 100, wherein the dolly storage system 100 is in an extended configuration 200 having the articulating arm 500 folded down. An operator 501 is shown folding the articulating arm 500 to access the dolly 107 prior to use and/or during the process of storing the dolly 107.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible considering the above teachings without departing from the following claims.

I/We claim:

1. A dolly storage system for storing a dolly in a bed of a pickup truck, comprising:
one or more slidable tubes positioned within an interior of a truck bed;
a dolly;
a mounting system connected to the one or more slidable tubes, the mounting system configured to connect to the dolly; and
an articulating arm coupling the mounting system to the dolly, wherein the one or more slidable tubes and the articulating arm are configured to enable movement of the dolly between a stowed configuration within the interior of the truck bed and an extended configuration outside of the truck bed.

2. The dolly storage system of claim 1, wherein the slidable tubes are telescoping members configured to lock at a plurality of extension lengths.

3. The dolly storage system of claim 1, wherein the articulating arm is foldable into a collapsed position when the dolly is in the stowed configuration.

4. The dolly storage system of claim 1, wherein the mounting system comprises a bracket having fasteners to secure the dolly during transport.

5. The dolly storage system of claim 1, wherein the slidable tubes are configured to extend linearly along the longitudinal axis of the truck bed.

6. The dolly storage system of claim 1, wherein the articulating arm is pivotally connected to the mounting system through a hinge mechanism.

7. The dolly storage system of claim 1, wherein the stowed configuration corresponds to the dolly being entirely within the walls and tailgate of the truck bed.

8. The dolly storage system of claim 1, wherein the system further comprises a locking mechanism to secure the articulating arm in either the stowed or extended position.

9. The dolly storage system of claim 1, wherein the mounting system is adjustably positionable to accommodate dollies of different widths or lengths.

10. A dolly storage system for a vehicle, comprising:
a plurality of telescoping tubes secured within a truck bed, the telescoping tubes being slidable between a retracted configuration and an extended configuration;
a base carriage fixed to the telescoping tubes;
an articulating linkage arm pivotally mounted to the base carriage; and
a dolly secured to the articulating linkage arm, wherein extension of the telescoping tubes and pivoting of the articulating linkage arm enable removal of the dolly from the truck bed without manual lifting by an operator.

11. The dolly storage system of claim 10, wherein the telescoping tubes are formed of nested square or circular hollow sections fabricated from metal.

12. The dolly storage system of claim 10, wherein the articulating linkage arm comprises a gas strut or spring assist for aiding the pivoting motion.

13. The dolly storage system of claim 10, wherein the base carriage is detachably mounted to the telescoping tubes via a locking pin assembly.

14. The dolly storage system of claim 10, wherein the dolly includes a wheel-locking mechanism to prevent movement during storage.

15. The dolly storage system of claim 10, wherein the system further comprises a manual or powered actuator for extending the telescoping tubes.

16. A vehicle-mounted dolly deployment system, comprising:
a track system disposed longitudinally within a truck bed, the track system having at least one telescoping rail;
a cradle platform mounted to the telescoping rail;
a swingable arm member affixed to the cradle platform, the swingable arm member configured to articulate in a lateral direction relative to the truck bed; and
a dolly secured to the swingable arm member, wherein the track system and the swingable arm member cooperate to transport the dolly between a storage position inside the truck bed and a deployment position adjacent the vehicle.

17. The vehicle-mounted dolly deployment system of claim 16, wherein the track system comprises at least two guide rails and a rolling platform bearing the cradle platform.

18. The vehicle-mounted dolly deployment system of claim 16, wherein the swingable arm member is configured to rotate at least 90 degrees from its stowed position.

19. The vehicle-mounted dolly deployment system of claim 16, wherein the cradle platform comprises a contoured support surface matching a base contour of the dolly.

20. The vehicle-mounted dolly deployment system of claim 16, wherein the dolly is secured to the swingable arm member through a removable latch mechanism.
